(19) United States
(12) Patent Application Publication
(10) Pub. No.: US 2026/0326786 A1
(43) Pub. Date: Oct. 22, 2026

(54) VEHICLE CONTROL DEVICE AND METHOD

(71) Applicants: Hyundai Motor Company, Seoul (KR); Kia Corporation, Seoul (KR)

(72) Inventor: Ji Hong KIM, Hwaseong-Si (KR)

(21) Appl. No.: 19/379,303

(22) Filed: Nov. 4, 2025

(30) Foreign Application Priority Data
Apr. 16, 2025 (KR) 10-2025-0049378

(51) Int. Cl. B60W 60/00; G06N 20/00

(52) U.S. Cl. CPC B60W 60/001; B60W 60/0053; G06N 20/00

(57) ABSTRACT

According to an example, there is provided a vehicle control device including a sensor unit, one or more processors, and a memory storing one or more programs executed by the one or more processors, the sensor unit generates vehicle driving data and external object recognition data of a host vehicle and generates a feedback signal input from an occupant during travel of the host vehicle, and the processor is configured to generate reward data based on the feedback signal, generate a training data set including the external object recognition data, the vehicle driving data, and the reward data, and perform reinforcement learning based on the training data set and control the vehicle based on the reinforcement learning.

### CROSS-REFERENCE TO RELATED APPLICATION

This application claims the benefit of priority to Korean Patent Application No. 10-2025-0049378, filed in the Korean Intellectual Property Office on Apr. 16, 2025, the disclosure of which is incorporated herein by reference in its entirety.

### TECHNICAL FIELD

Examples relate to a vehicle control device and method are introduced.

### BACKGROUND

The matters described in this Background section are only for enhancement of understanding of the background of the disclosure, and should not be taken as acknowledgment that they correspond to prior art already known to those skilled in the art.

Reinforcement learning (RL) may be a powerful tool for optimizing vehicle driving policies. In particular, reinforcement learning may be a method of learning optimal actions through interaction with the environment, and unlike other supervised learning, has the advantage that explicit labeled data may not be required.

However, the performance of reinforcement learning may be highly dependent on a reward function, and there is a limitation in that it may be difficult to obtain expected results when the reward function is not exactly aligned with an actual goal.

Representative examples where reinforcement learning may show excellent performance include environments having clear goals and reward structures, such as Go, chess, and Atari games. In these environments, there may be an intuitive and concrete reward function, such as winning or scoring, and an agent may be optimized to maximize the reward function.

However, in real-world applications such as autonomous driving, the goal may be complex, and it is challenging to clearly define the reward function in advance. In the case of autonomous driving, various factors such as safety, ride comfort, compliance with regulations, and energy efficiency may be considered, and these factors are challenging to express with simple numerical compensation.

Therefore, even if the reward function is defined, reinforcement learning may potentially proceed in an unintended direction.

### SUMMARY

Various examples of the present disclosure provide a vehicle control device and method capable of designing reinforcement learning by reflecting feedback from occupants and controlling the behavior of a vehicle based on the reinforcement learning.

According to the present disclosure, an apparatus of a vehicle may comprise a sensor, a processor, and a memory storing at least one instruction that, when executed by the processor communicating with the memory, is configured to cause the apparatus to obtain, from the sensor, vehicle driving data associated with the vehicle and external object recognition data associated with an object in a surrounding environment of the vehicle, based on input from an occupant of the vehicle during travel of the vehicle, generate a feedback signal, generate, based on the feedback signal, weight data, generate a training data set, the training data set may comprise the external object recognition data, the vehicle driving data, and the weight data, perform, based on the training data set, reinforcement learning to adjust control parameters associated with autonomous driving of the vehicle, and control, based on the adjusted control parameters, autonomous driving of the vehicle.

The sensor may be configured to generate a first feedback signal, wherein the first feedback signal is generated based on at least one of a first autonomous driving deactivation signal or a second autonomous driving deactivation signal. The first autonomous driving deactivation signal may be generated based on a signal obtained via an input interface of the vehicle, and the second autonomous driving deactivation signal may be generated based on a detected behavior of the occupant.

When autonomous driving is deactivated according to the first feedback signal, the at least one instruction, when executed by the processor communicating with the memory, may cause the apparatus to perform the reinforcement learning by assigning a negative weight to the training data set.

The at least one instruction, when executed by the processor communicating with the memory, may cause the apparatus to control, based on the reinforcement learning, the vehicle in a direction in which an autonomous driving state is maintained. The sensor may be configured to generate a second feedback signal based on at least one of an input signal generated based on a user input received via an input interface of the vehicle, or a detected behavior of the occupant.

Based on the second feedback signal, the at least one instruction, when executed by the processor communicating with the memory, may cause the apparatus to determine a positivity value associated with a behavior of the occupant, and perform, based on the positivity value, the reinforcement learning by assigning a positive weight or a negative weight to the training data set. The at least one instruction, when executed by the processor communicating with the memory, may cause the apparatus to control, based on the reinforcement learning, the vehicle in a direction in which a positive behavior of the occupant is induced. The at least one instruction, when executed by the processor communicating with the memory, may further cause the apparatus to determine, based on the reinforcement learning, a driving trajectory of the vehicle, and display, via a display, the driving trajectory.

The at least one instruction, when executed by the processor communicating with the memory, may cause the apparatus to determine, based on the weight data, suitability of the driving trajectory.

When a training data set has a driving trajectory score greater than or equal to a preset threshold value, the at least one instruction, when executed by the processor communicating with the memory, may cause the apparatus to perform imitation learning, and based on the imitation learning and the reinforcement learning, control autonomous driving of the vehicle.

According to the present disclosure, a method may be performed by an apparatus of a vehicle. The method may comprise obtaining, from a sensor of the vehicle, vehicle driving data associated with the vehicle and external object recognition data associated with an object in a surrounding environment of the vehicle, based on input from an occupant of the vehicle during travel of the vehicle, generating a feedback signal, generating, based on the feedback signal, weight data, generating a training data set, the training data set may comprise the external object recognition data, the vehicle driving data, and the weight data, performing, based on the training data set, reinforcement learning to adjust control parameters associated with autonomous driving of the vehicle, and controlling, based on the adjusted control parameters, autonomous driving of the vehicle.

According to the present disclosure, a vehicle may comprise a sensor, a driving control circuit configured to control autonomous driving of the vehicle, and a processor circuit configured to cause the vehicle to obtain, from the sensor, driving data associated with the vehicle and external object data associated with an object in a surrounding environment of the vehicle, detect a feedback signal associated with an occupant of the vehicle during travel of the vehicle, wherein the feedback signal indicates at least one of a manual override action, a biometric change, a physical action, or a voice input, generate, based on the feedback signal, control adjustment data, determine a training data set, the training data set may comprise the driving data, the external object data, and the control adjustment data, perform, based on the training data set, a learning process to adjust a set of autonomous driving control parameters of the driving control circuit, and control, via the driving control circuit and based on the adjusted set of autonomous driving control parameters, autonomous driving of the vehicle.

The processor circuit may cause the vehicle to assign a negative weight to the training data set when the feedback signal corresponds to deactivation of autonomous driving.

The processor circuit may cause the vehicle to assign a positive weight or a negative weight to the training data set according to whether the feedback signal indicates comfort or discomfort of the occupant of the vehicle. The processor circuit may cause the vehicle to perform, based on a second training data set, imitation learning, wherein the second training data set is associated with a driving trajectory having a suitability score satisfying a threshold value, and may cause the vehicle to control the autonomous driving of the vehicle such that driving behavior corresponding to a positive feedback signal associated with the occupant is retained and driving behavior corresponding to a negative feedback signal associated with the occupant is suppressed.

### BRIEF DESCRIPTION OF THE DRAWINGS

The above and other objects, features and advantages of the present disclosure will become more apparent to those of ordinary skill in the art by describing examples thereof in detail with reference to the accompanying drawings, in which:

FIG. 1 shows an example of a vehicle transmitting and receiving data by communicating with other devices;

FIG. 2 shows exemplary modules constituting a vehicle;

FIG. 3 shows an example of a vehicle control device;

FIG. 4, FIG. 5, FIG. 6, FIG. 7, FIG. 8, and FIG. 9 show an exemplary operation of a processor according to the example;

FIG. 10, FIG. 11, and FIG. 12 show an exemplary flowcharts of a method of controlling a vehicle; and

FIG. 13 shows an example of a computing system.

### DETAILED DESCRIPTION

Hereinafter, preferred examples of the present disclosure will be described in detail with reference to the accompanying drawings.

However, the technical idea of the present disclosure is not limited to some examples to be described but may be implemented in various different forms, and within the scope of the technical idea of the present disclosure, one or more among components in the examples may be used by being selectively combined and substituted.

Further, unless specifically defined and described, terms used in the examples of the present disclosure (including technical and scientific terms) may be interpreted as meanings which are generally understood by those skilled in the art to which the present disclosure pertains, and commonly used terms such as terms defined in dictionaries may be interpreted in consideration of the contextual meaning of the related art.

The terms used in the examples of the present disclosure are for the purpose of describing the examples only and are not intended to limit the disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B. In addition, when describing components of examples of the present disclosure, terms such as first, second, A, B, (a), (b), etc., may be used.

These terms are only for distinguishing the components from other components, and the essence, sequence, or order of the components is not limited by these terms.

In addition, when a component is described as being “linked,” “coupled,” or “connected” to another component, the component is not only directly linked, coupled, or connected to another component, but also “linked,” “coupled,” or “connected” to another component with still another component disposed between the component and the other component.

Further, when a component is described as being formed or disposed “on (above) or under (below)” another component, the term “on (above) or under (below)” includes not only when two components are in direct contact with each other, but also when one or more other components are formed or disposed between the two components. Further, when a component is described as being “on (above) or below (under),” the description may include the meanings of an upward direction and a downward direction based on one component.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., adaptive autonomous driving control using occupant feedback signals for reinforcement and imitation learning) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., adaptive autonomous driving control using occupant feedback signals for reinforcement and imitation learning) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., adaptive autonomous driving control using occupant feedback signals for reinforcement and imitation learning) described herein.

Minimum risk maneuver (MRM) operation(s) may also be controlled, for example, based on one or more features (e.g., adaptive autonomous driving control using occupant feedback signals for reinforcement and imitation learning) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., adaptive autonomous driving control using occupant feedback signals for reinforcement and imitation learning) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., adaptive autonomous driving control using occupant feedback signals for reinforcement and imitation learning) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving level and/or autonomous driving activation/deactivation may also be controlled, for example, based on one or more features (e.g., adaptive autonomous driving control using occupant feedback signals for reinforcement and imitation learning) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

Hereinafter, examples will be described in detail with reference to the accompanying drawings, but the same or corresponding components are denoted by the same reference numerals regardless of the drawing numbers, and redundant descriptions thereof will be omitted.

According to the present disclosure, a vehicle control device and method are provided that improve autonomous driving by incorporating occupant feedback into reinforcement learning. A sensor generates vehicle driving data and external object recognition data, and also detects feedback signals from an occupant, such as manual override actions, biometric changes, or voice inputs. A processor circuit generates reward data based on the feedback signals, creates a training data set including the reward data, and performs reinforcement learning to update driving policies. Negative rewards may be assigned when autonomous driving is deactivated or when discomfort signals are detected, while positive rewards may be assigned when comfort signals are observed. The processor circuit controls the vehicle based on the updated policies to maintain safe and natural driving, and may further utilize imitation learning by selecting high-quality training data. Through this approach, the driving behavior of the vehicle is adaptively refined to reflect safety, comfort, and occupant preferences.

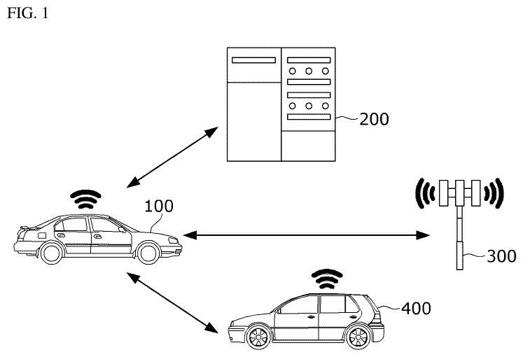

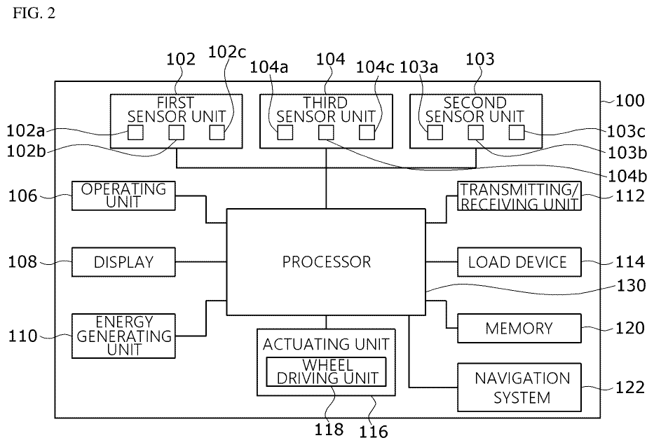

Hereinafter, a vehicle will be described with reference to FIGS. 1 and 2. FIG. 1 is a view illustrating a vehicle transmitting and receiving data by communicating with other devices.

Referring to FIG. 1, a vehicle 100 may be driven based on electrical energy or fossil energy. In the case of electrical energy, the vehicle 100 may be, for example, a pure battery-based vehicle driven only by a high-voltage battery, or may employ a gas-based fuel cell as an energy source. In addition, the fuel cell may use various types of gas capable of generating electrical energy, and the vehicle 100 may be filled with gas, for example, in a liquefied state. Here, one example of the gas may be hydrogen. However, the gas is not limited thereto, and various gases are applicable (e.g., methane, ammonia, natural gas, or biogas, etc.). In the case of a vehicle driven based on fossil energy, the vehicle 100 is driven based on fuel such as gasoline, diesel or liquefied gas, and may be equipped with an internal combustion engine that drives an actuating unit 116 by combustion of the fuel. The engine may be included in an energy generating unit 110 in terms of providing a driving rotational force of wheels to a wheel driving unit 118. As another example, the vehicle 100 may drive the actuating unit 116 by selectively utilizing energy from a fossil energy-based internal combustion engine and an electric battery, and may be a hybrid type vehicle (e.g., parallel hybrid, series hybrid, plug-in hybrid, or mild hybrid, etc.).

The vehicle 100 may refer to a movable device. The vehicle 100 is a ground vehicle that travels on the ground and may be a typical passenger car, a commercial vehicle, a purpose-built vehicle (PBV), or the like (e.g., taxi, delivery van, or ride-sharing shuttle, etc.). The vehicle 100 may be a four-wheeled vehicle, such as a passenger car, a sport utility vehicle (SUV), or a small truck, or may be a vehicle with more than four wheels, such as a bus, a large truck, a container transport vehicle, a heavy equipment vehicle, dump truck, fire truck, crane, or excavator, etc. Here, the ground vehicle may be referred to as any vehicle including a vehicle that moves underground as well as a vehicle that moves over land. The vehicle 100 may be a robot in a broad sense, such as a means of movement, and the robot may move using wheels, tracks, or other movement modules. In the present disclosure, ground mobility devices such as ground vehicles are mainly described, but unless it contradicts the present disclosure, the present example may also be applied to air mobility devices such as an advanced air mobility (AAM), aircraft, or the like, and water mobility devices such as ships, submarines, or the like.

The vehicle 100 may be controlled and driven by autonomous driving, and the autonomous driving may be implemented as semi-autonomous driving or fully autonomous driving. Fully autonomous driving may be provided as autonomous movement in which a processor 130 of the vehicle 100 takes full control without user intervention (e.g., lane keeping, automatic overtaking, highway merging, or parking without assistance, etc.), even if a driving situation is uncertain. Semi-autonomous driving may be provided as autonomous movement that requires driver intervention depending on specific driving situations (e.g., construction zones, poor weather, unusual traffic signals, or emergency vehicle approach, etc.). The semi-autonomous driving may be implemented so that the processor 130 transfers control to a user by deactivating autonomous driving when the aforementioned situation occurs, allowing the user to perform manual driving. According to the levels of autonomous driving defined by the Society of Automotive Engineers (SAE), the semi-autonomous driving may correspond to autonomous driving levels 1 to 4, and the fully autonomous driving may correspond to level 5.

The vehicle 100 may communicate with other devices 200 and 300 or another vehicle 400. Other devices may include, for example, a server 200 that supports various controls, state management, and driving of the vehicle 100, an intelligent transportation system (ITS) device 300 for receiving information from an ITS, or various types of user devices (e.g., smartphones, wearable devices, or tablets, etc.). The server 200 may be, for example, an external device operated by a vehicle manufacturer or provided to service autonomous driving, and may receive connected data of the vehicle 100 or transmit data necessary for autonomous driving. The server 200 may transmit various pieces of information and software modules (e.g., navigation updates, hazard alerts, AI-based driving strategies, or infotainment services, etc.) used to control the vehicle 100 to the vehicle 100 in response to requests and data transmitted from the vehicle 100 and the user device to support autonomous driving and various services of the vehicle 100.

The ITS device 300 may be, for example, a roadside unit (RSU), and the ITS device 300 may assist the user in driving his or her own vehicle or support autonomous driving of the vehicle 100 by exchanging vehicle recognition data, driving control and state data, environmental data around the vehicle, map data, or the like, through vehicle-to-infrastructure (V2I) communication with the vehicle 100 (e.g., signal phase and timing data, toll information, road hazard broadcasts, or congestion updates, etc.). The vehicle 100 may support manual driving or autonomous driving (e.g., cooperative adaptive cruise control, collision warning, or platooning, etc.) by exchanging the data listed above through vehicle-to-vehicle (V2V) communication with the other vehicle 400.

The vehicle 100 may communicate with other vehicles or other devices based on cellular communication, wireless access in vehicular environment (WAVE) communication, dedicated short range communication (DSRC), short-range communication, or other communication methods.

For example, the vehicle 100 may use a cellular communication network such as LTE or 5G, a WiFi communication network, a WAVE communication network, or the like, for communication with the server 200, the ITS device 300, and the other vehicle 400. For another example, dedicated short range communication (DSRC) or Bluetooth, Wi-Fi Direct, satellite communication used in the vehicle 100 may be used for communication between vehicles. The communication method between the vehicle 100, the server 200, the ITS device 300, the other vehicle 400, and the user device is not limited to the above-described example.

FIG. 2 shows exemplary modules constituting a vehicle according to one example of the present disclosure.

The vehicle 100 may include a sensor unit 102, an operating unit 106, a display 108, a load device 114, and a transmitting/receiving unit 112.

The sensor unit 102 may be provided with various types of detectors to detect various states and situations occurring in an external environment, an internal system, a user operation, and a boarding space of the vehicle 100 (e.g., monitoring tire pressure, detecting rain on the windshield, identifying pedestrian movements, or sensing driver fatigue, etc.).

Specifically, a first sensor unit 102 may be provided with an externally oriented camera 102a, a lidar sensor 102b, a radar sensor 102c, and the like (e.g., an ultrasonic sensor, infrared sensor, thermal imaging sensor, or night-vision camera, etc.), to recognize dynamic and static objects present outside the vehicle 100. The camera 102a may recognize an external object (e.g., vehicle outline, pedestrian silhouette, or roadside barrier shape, etc.) as an image while the vehicle 100 is in use, generate image data, and transmit the image data to the processor 130. The lidar sensor 102b may generate point cloud data as recognized data of the external object and transmit the point cloud data to the processor 130 to generate 3D spatial information that identifies at least a shape of the external object. In order to ascertain the presence of an external object and its relative distance, speed, direction, or the like, the radar sensor 102c may emit radio waves of a specific frequency around the vehicle 100 and generate radar data through radio waves reflected from the external object (e.g., other cars, cyclists, traffic signs, or animals, etc.). In the present disclosure, the sensor unit is illustrated as having the lidar sensor 102b, but in other examples, the lidar sensor 102b may not be mounted.

The first sensor unit 102 may generate object recognition information based on sensing data. The object recognition information may include information on the presence of an object, position information about the object, information on a distance between the vehicle 100 and the object, and information on a relative speed between the vehicle 100 and the object (e.g., approaching vehicle, crossing pedestrian, or stopped obstacle, etc.). In the example, the external objects may be various objects related to the operation of the vehicle 100.

A second sensor unit 103 may be provided with a positioning sensor 103a, a wheel sensor 103b, an attitude sensor 103c, and the like (e.g., a GPS receiver, magnetometer, or barometric pressure sensor, etc.), to confirm its own location, speed, driving attitude, and the like. The attitude sensor 103c may include a gyro sensor, an angular velocity sensor, an acceleration sensor, or the like. The attitude sensor may be an inertial measurement unit (IMU) sensor and may be equipped with a 3-axis accelerometer and a 3-axis gyroscope. The attitude sensor may measure acceleration in a traveling direction (x), acceleration in a lateral direction (y), and acceleration in a height direction (z) of the vehicle 100, and a yaw, a pitch, and a roll as the angular velocity of the vehicle (e.g., yaw drift during a turn, pitch changes on a slope, or roll while cornering, etc.).

The second sensor unit 103 may generate vehicle driving information based on sensing data. The vehicle driving information may be information generated based on data detected by various sensors installed inside the vehicle. For example, the vehicle driving information may include vehicle attitude information, vehicle speed information, vehicle inclination information, vehicle weight information, vehicle direction information, vehicle battery information, vehicle fuel information, vehicle tire pressure information, vehicle steering information, vehicle interior temperature information, vehicle interior humidity information, pedal position information, vehicle engine temperature information, and the like (e.g., brake fluid temperature, oil pressure level, cabin air quality, or vibration information, etc.).

In addition, the vehicle driving information may include route information. The route information may refer to information generated based on a destination input by a vehicle user through the operating unit 106. The route information may refer to information that indicates a driving route from a current position of a host vehicle to a destination on a map when the destination has been set (e.g., highway route, shortest local road, toll-free route, or scenic route, etc.). When no destination is set, the route information may refer to information including a road on which the host vehicle is currently traveling and a future driving route including the road (e.g., predicted next intersection, upcoming exit, or estimated continuation on the current lane, etc.).

A third sensor unit 104 may include a voice sensor 104a that collects voice signals inside the vehicle, a biometric sensor 104b disposed near the occupant, and a camera 104c that captures the inside of the vehicle.

The voice sensor 104a may include at least one microphone disposed inside the vehicle, and may collect voices, humming sounds, spoken commands (e.g., “speed up,” “slow down,” or “stop”), distress sounds (e.g., screams, coughs, or heavy breathing), or background noises (e.g., music or environmental sounds) expressed by the occupant inside the vehicle to generate a voice signal.

The biometric sensor 104b may include at least one heart rate measurement sensor disposed at a location that may be touched by an occupant's body, and the biometric sensor 104b may measure an occupant's heart rate at the measurement location to generate a biometric signal. In addition to heart rate, the biometric sensor 104b may also detect skin temperature, perspiration level, or blood oxygen saturation (e.g., SpO₂, galvanic skin response, or temperature-based stress indicators), thereby generating diverse biometric signals useful for assessing the occupant's condition.

The camera 104c may capture the inside of the vehicle, and may be disposed to face the front of the upper body of the occupant, thereby generating a video signal by capturing the movements of the occupant. The camera 104c may further detect facial expressions, eye blinking frequency, gaze direction, or posture changes (e.g., leaning forward, crossing arms, or sudden jerks), which may be analyzed to identify levels of comfort, drowsiness, or stress of the occupant.

The operating unit 106 may be configured as a module that is controlled by the user for driving. For example, the operating unit 106 may be a steering wheel for manual driving, an automatic or manual shift transmission, an accelerator pedal, a brake pedal, a clutch pedal, gear lever, or joystick-type controller, or the like. The operating unit 106 may be further provided with an interface for enabling or disabling an autonomous driving mode and selecting detailed functions requested by the user so that the user may use an autonomous driving function. In order to receive various requests related to autonomous driving, the operating unit 106 may be configured, for example, as a hard-type interface provided at a predetermined position inside the vehicle 100, or as a soft-type interface that may be touched on the display 108 (e.g., touchscreen buttons, voice command interface, or gesture-based control, etc.). Depending on the specifications of the autonomous vehicle, at least one of the steering wheel, the transmission, and the pedal may be omitted. For another example, the operating unit 106 may be provided with a module that receives a user's control request for the load device 114 in addition to driving control.

The display 108 may function as an operating unit. The display 108 may output and display an operating state, a control state, route/traffic information, remaining energy amount information, content requested by the driver, or the like, of the vehicle 100 under the control of the processor 130 (e.g., displaying navigation maps, real-time fuel/battery status, multimedia content, or vehicle diagnostic alerts, etc.). In addition, the display 108 may be configured as a touch screen capable of detecting a driver's input to receive a driver's request to instruct the processor 130.

The load device 114 is mounted on the vehicle 100 and may be a type of non-driving electrical device not including a driving power system such as the wheel driving unit 118 or the like. The load device 114 is an auxiliary device that receives electrical power from the energy generating unit 110, and may be, for example, an air conditioning system, a lighting system, a seat system, various devices installed in the vehicle 100, or the like (e.g., infotainment system, power windows, or onboard refrigerator, etc.). In the present disclosure, a cooling/heating system that cools or heats at least one of a battery, a fuel cell, an internal combustion engine, an air conditioning system, and a specific part of the vehicle 100 may be further included.

The transmitting/receiving unit 112 may support mutual communication with the server 200, the ITS device 300, adjacent vehicles 400, and the like. The transmitting/receiving unit 112 may include a module that processes, for example, cellular communication, WAVE communication, DSRC, and the like (e.g., 5G-based V2X communication, Bluetooth, or Wi-Fi Direct, etc.). In the present disclosure, the transmitting/receiving unit 112 may transmit data generated or stored while driving to the server 200 and receive data and software modules transmitted from the server 200. The transmitting/receiving unit 112 may support communication with an electronic device carried by an occupant inside the vehicle 100 (e.g., a smartphone, tablet, or wearable device, etc.). In the present disclosure, the vehicle 100 may transmit and receive data utilized in a method according to the present disclosure to and from the outside through the transmitting/receiving unit 112.

For example, the transmitting/receiving unit 112 may receive traffic signal information from a traffic signal controller and provide the traffic signal information to the processor 130 (e.g., red light timing, green light countdown, or priority vehicle signaling, etc.). In addition, the transmitting/receiving unit 112 may receive a control signal from the traffic signal controller and provide the control signal to the processor 130.

In addition, the vehicle 100 may include the energy generating unit 110 and the actuating unit 116.

The energy generating unit 110 may generate and supply power and electric power used in a driving power system such as the actuating unit 116 and a non-driving power system. The non-driving power system may be, for example, the sensor unit 102, the operating unit 106, the display 108, the load device 114, and the transmitting/receiving unit 112, but is not limited thereto, and may include various components that implement sensing, interface, communication, and convenience functions, not including components directly involved in driving operations (e.g., entertainment systems, climate control units, or auxiliary safety sensors, etc.). When the vehicle 100 is driven based on electrical energy, the energy generating unit 110 may be configured as an electric battery charged from the outside, or configured as a combination of an electric battery and a fuel cell that charges the electric battery. In the case of a vehicle driven based on the combination of the electric battery and the fuel cell, the energy generating unit 110 may include a tank that stores materials used to produce electric power for the fuel cell, such as liquefied hydrogen (e.g., cryogenic hydrogen, compressed hydrogen, or methanol reforming fuel, etc.). When the vehicle 100 is driven based on fossil energy, the energy generating unit 110 may be configured as an internal combustion engine. In addition, when the vehicle 100 is a hybrid type, the energy generating unit 110 may be provided as a combination of the internal combustion engine and the electric battery.

The actuating unit 116 may be provided with at least one module that implements driving operations and performs at least one driving operation among longitudinal control such as acceleration and deceleration and lateral control such as steering, according to a user request from the operating unit 106. In order to perform driving operations according to a command of the processor 130 by manual operation of the user or autonomous driving, the actuating unit 116 may be provided with the wheel driving unit 118 and mechanical components and electronic modules for implementing the driving operations in the wheel driving unit 118. When the vehicle 100 is operated based on electrical energy, the actuating unit 116 may include an assembly for transmitting the requested driving operation to the wheel driving unit 118. When the vehicle 100 is operated based on fossil energy, the actuating unit 116 may be provided with a transmission and a gear module that transmit the power of the internal combustion engine (e.g., automatic gearbox, continuously variable transmission (CVT), or dual-clutch transmission, etc.).

The wheel driving unit 118 may include a plurality of wheels, a driving force generation module for generating a driving force and applying the driving force to the wheels or transmitting the driving force, a braking module for slowing down the driving of the wheels, and a steering module for carrying out lateral control of the wheels (e.g., electric power steering, hydraulic steering, or steer-by-wire systems, etc.). When the vehicle 100 is driven based on electrical energy, the driving force generating module may be configured as a motor assembly that generates a driving force based on electric power output from the electric battery. The braking module of the electric-based vehicle 100 may further have a regenerative braking function.

A navigation system 122 may provide navigation information. The navigation information may include at least one of map information, set destination information, route information according to a set destination, information on various objects on the path, lane information, and current vehicle position information (e.g., toll booth locations, charging stations, rest areas, or accident zones, etc.).

The navigation system 122 may receive information from an external device through the transmitting/receiving unit 112 and update previously stored information. According to the example, the navigation system 122 may be classified as a sub-component of the operating unit 106.

In addition, the vehicle 100 may include a memory 120 and the processor 130.

The memory 120 may store applications and various types of data for controlling the vehicle 100, and load applications or read and record data by a request of the processor 130 (e.g., storing navigation maps, diagnostic logs, multimedia content, or autonomous driving algorithms, etc.).

The processor 130 may perform overall control of the vehicle 100. The processor 130 may be configured to execute applications and instructions stored in the memory 120 (e.g., path planning software, collision avoidance logic, or driver monitoring algorithms, etc.).

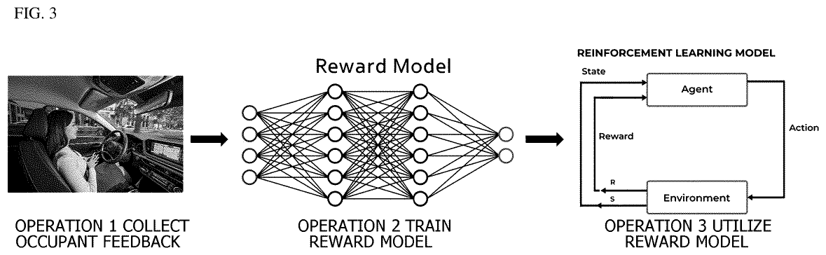

FIG. 3 shows an example of a vehicle control device according to an example. Referring to FIG. 3, a vehicle control device 10 according to the example may include a sensor unit 11, a processor 12, and a memory 13. The sensor unit 11 of FIG. 3 may have a configuration including the first to third sensor units in FIG. 2, and the processor 12 and the memory 13 in FIG. 3 may have the same configuration as the processor and the memory in FIG. 2.

The processor 12 may perform overall control of the vehicle control device 10, and may be configured to execute applications and instructions stored in the memory 13.

The sensor unit 11 may generate vehicle driving data and external object recognition data of a host vehicle, and collect feedback signals input from an occupant during travel of the host vehicle.

The sensor unit 11 may collect an autonomous driving deactivation signal input through the operating unit (e.g., user interface) as a first feedback signal. In this case, the operating unit may have the same configuration as the operating unit in FIG. 2, and the occupant may input various requests related to autonomous driving through the operating unit (e.g., disabling lane-keeping, adjusting cruising speed, or stopping autonomous mode).

Alternatively, the sensor unit 11 may generate a first feedback signal based on at least one of an autonomous driving deactivation signal input through the operating unit and an autonomous driving deactivation signal input based on the behavior of the occupant detected inside the vehicle (e.g., sudden steering wheel movement, pressing the brake pedal, or forceful accelerator input).

In a state in which autonomous driving is activated, the occupant may input the autonomous driving deactivation signal directly through the operating unit (e.g., touching a deactivation button, toggling a switch, or issuing a voice command such as “manual mode”) to switch to manual driving.

Alternatively, in the state in which autonomous driving is activated, the sensor unit 11 may detect an instance in which the occupant grips a steering wheel or presses a brake/accelerator and recognize the instance as the autonomous driving deactivation signal (e.g., quick wheel rotation, sharp brake pressure, or sudden accelerator depression).

In this way, when the occupant overrides the system during autonomous driving, this may mean that the vehicle driving policies are not satisfactory, and the first feedback signal may then be reflected as a negative reward during reinforcement learning.

For example, when the vehicle accelerates too quickly (e.g., sudden throttle surge or jerky speed increase) or changes lanes too aggressively (e.g., abrupt lateral movement without sufficient clearance or sharp steering correction) in the autonomous driving mode, the occupant may deactivate autonomous driving by gripping the steering wheel or pressing the brake, and the sensor unit 11 may recognize this as the autonomous driving deactivation signal and generate the first feedback signal.

The sensor unit 11 may generate a second feedback signal based on at least one of a signal input through the operating unit (e.g., pressing a comfort/discomfort button, selecting a touch screen option, or issuing a spoken command such as “slow down” or “good drive”) and the behavior of the occupant detected inside the vehicle (e.g., facial expressions, posture changes, heart rate variations, or sudden body movements).

The sensor unit 11 may detect the behavior of the occupant in the state in which autonomous driving is activated or deactivated and generate the detected behavior as second feedback (e.g., pressing a comfort/discomfort button, issuing a voice command, changing facial expression, or producing a biometric response).

For example, depending on a driving state of the vehicle, the occupant may express feedback such as “driving too fast,” “driving too slow,” or “lane changes are unnatural” or the like through actions or through biometric signals. In this case, the behavior of the occupant may be detected by biometric signals (e.g., an increased heart rate, reduced blood oxygen, or elevated skin conductance), behavioral signals detected by in-vehicle cameras (e.g., facial expression analysis, gaze tracking, or body movements), physical input signals (e.g., sudden steering wheel movements, strong pressure on the brake pedal, or abrupt accelerator actions), voice signals (e.g., an “uncomfortable” button, voice commands, saying “slow down,” “unsafe,” or “comfortable”, etc.), or the like (e.g., pressing a designated feedback button).

As described above, the behavior of the occupant (e.g., a happy expression, an anxious expression, drowsy eyelid movements, a sudden change in posture, a change to a more relaxed posture, an increase or decrease in heart rate, pressing the brake pedal, or gripping the steering wheel, or making corrective steering inputs, etc.) may be an important signal reflecting how the occupant feels about the driving comfort of the vehicle. Therefore, the second feedback signal may be reflected as a positive reward when the behavior indicates satisfaction or comfort (e.g., relaxed posture or calm heart rate) or a negative reward when the behavior indicates discomfort or stress (e.g., anxious expression, high heart rate, or forceful pedal input) in reinforcement learning.

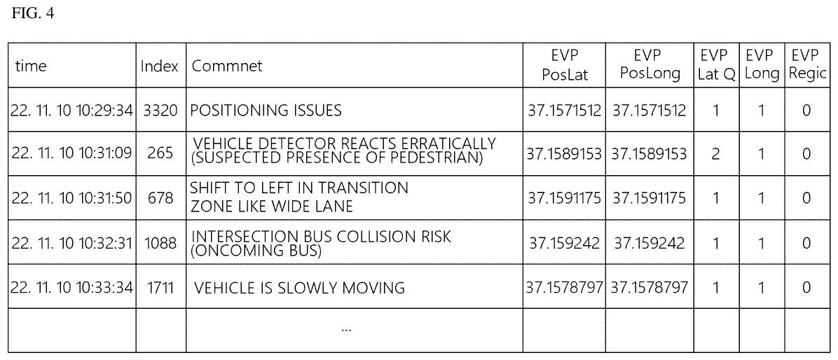

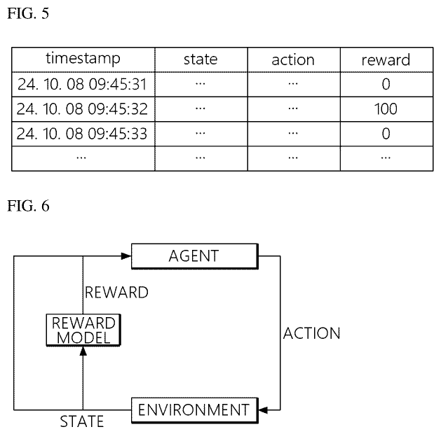

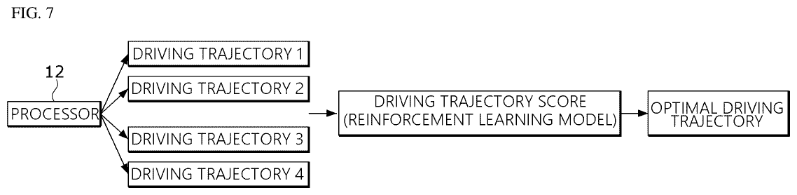

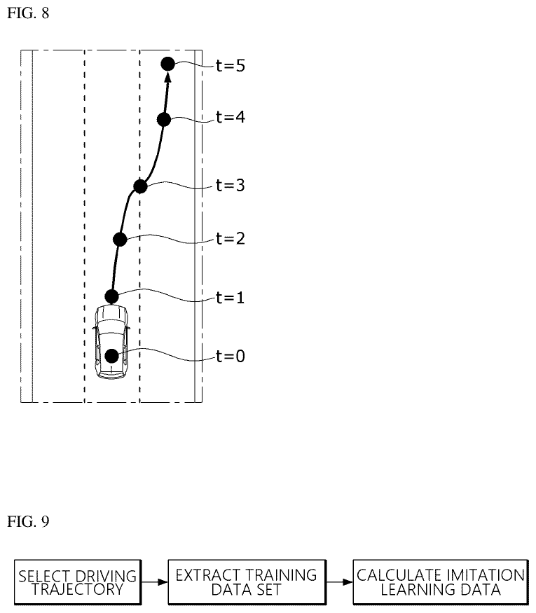

FIG. 4 is a view for describing a feedback signal according to an example. Referring to FIG. 4, the feedback signal may include timestamp, index, and comment information. The index may refer to the results of classifying a type of the behavior of the occupant or the type of input information according to the degree of positivity/negativity (e.g., strongly negative, mildly negative, neutral, mildly positive, or strongly positive). In addition, the comment is a detailed description of what causes the behavior of the occupant, and may be generated by analyzing signals input through the occupant's voice (e.g., spoken words such as “too fast,” “slow down,” “smooth ride,” or “comfortable”). The feedback signal may be analyzed by the processor 12 as described below and utilized to determine the positivity of the behavior of the occupant.

FIGS. 5 and 6 show an exemplary operation of the processor 12 according to the example. Referring to FIGS. 5 and 6 together, in the example, a reinforcement learning model may be composed of an agent, which is an entity performing learning, an environment, which is a space in which the agent interacts, a state(S), which is information indicating a current state of the environment, an action (A), which is a choice that the agent may perform (e.g., accelerate, decelerate, change lane, or maintain lane), a reward (R), which is a result that utilizes a result of the agent performing the action as feedback, and a policy (x), which is a strategy that determines which action to select in a given state.

The processor 12 may calculate an expected value of a reward that the vehicle will receive in the short or long term based on a feedback signal from the occupant in a specific state. For example, the processor 12 may calculate an expected value of a future reward given according to the feedback signal from the occupant when action a is performed in states (e.g., predicting a positive reward if gradual acceleration in congested traffic keeps the occupant calm, or predicting a negative reward if a sudden lane change in the same situation causes the occupant to grip the steering wheel or show stress).

In this case, the processor 12 may use a discount factor γ to determine what degree of importance to consider regarding the value of future rewards. The discount factor may have a value between 0 and 1, when the discount factor is 0, immediate rewards are considered based on the feedback signal from the occupant, and as γ approaches 1, more importance may be placed on long-term rewards (e.g., prioritizing smoother driving over several minutes rather than only a single quick maneuver).

In the example, to the reinforcement learning model, algorithms such as the Q-learning algorithm, the deep Q-network (DQN) algorithm, proximal policy optimization (PPO), or other reinforcement learning algorithms (e.g., actor-critic or Monte Carlo tree search) may be applied.

In the example, the processor 12 may generate reward data based on the feedback signal (e.g., assigning a negative value when the occupant deactivates autonomous driving or a positive value when the occupant remains relaxed).

In addition, the processor 12 may generate a training data set including external object recognition data, vehicle driving data, and reward data so that both the vehicle's external environment (e.g., adjacent vehicles, pedestrians, or traffic lights) and the internal occupant response are reflected.

In addition, the processor 12 may perform reinforcement learning based on the training data set, determine the behavior of the host vehicle based on results of the reinforcement learning, and control the host vehicle accordingly (e.g., adjusting lane-change timing, modifying acceleration patterns, or adapting braking intensity).

In the training data, the timestamp is a record of time when the occupant's feedback occurs, and may be used to synchronize the external object recognition data, the vehicle driving data, and the reward data so that the system may align a specific occupant reaction (e.g., sudden brake override at time t) with the exact vehicle state and external objects present at that moment.

The external object recognition data may refer to object data such as adjacent vehicles, pedestrians, and traffic lights by utilizing lidar, cameras, radar, or other sensors (e.g., ultrasonic sensors or infrared detectors). The external object recognition data may be used to analyze what objects are present and what driving environment is established around the vehicle at the moment when the occupant's feedback occurs.

The vehicle driving data may refer to driving data such as the speed, acceleration, steering angle, brake input, and the like of the host vehicle. The vehicle driving data may be used to learn what state the host vehicle is in when occupant feedback occurs, for example, identifying whether the vehicle was accelerating, braking, changing lanes, or navigating an intersection.

The agent of the processor 12 may determine the behavior of the vehicle based on the external object recognition data (state, s) and calculate the driving data (action, A) of the vehicle based on the behavior of the vehicle. For example, the processor 12 may analyze a state according to the external object recognition information (lanes, traffic lights, adjacent vehicles, road signs, or pedestrian crossings) and determine actions such as speed control (acceleration, deceleration, or maintaining speed), lane changes, evasive maneuvers, turning at an intersection, or merging into traffic based on the state.

When the feedback signal from the occupant is input according to the driving state of the vehicle, the processor 12 may generate the training data set by generating the generated feedback signal as the reward data. The processor 12 may perform training using the training data set including the reward data and update the policy of the reinforcement learning model. The processor 12 may repeat this process to train an optimal policy in a direction in which the reward data is maximized (e.g., smoother acceleration, safer lane changes, or steadier cruising speed) and design a driving policy for determining the behavior of the vehicle using the trained model so that future control decisions consistently reflect both safety and occupant comfort.

In the example, the processor 12 may generate the training data set composed of the time stamp, the state, the action, and the reward.

For example, the state of the training data set may be defined as in Table 1, and the action may be defined as in Table 2. However, parameters that constitute the state and action are not limited thereto, and various pieces of information collected during vehicle traveling may be added as needed (e.g., road curvature, weather conditions, or traffic density).

TABLE 1

| STATE VARIABLE | DESCRIPTION |
|---|---|
| S₁ | VEHICLE SPEED |
| S₂ | LANE POSITION |
| S₃ | ACCELERATION AND DECELERATION |
| S₄ | DISTANCE TO ADJACENT VEHICLE |
| S₅ | OCCUPANT FEEDBACK SIGNAL |
| | (DEACTIVATED) |
| S₆ | OCCUPANT OPERATION |
| | (DISCOMFORT DETECTED) |

TABLE 2

| ACTION | DESCRIPTION |
|---|---|
| a₁ | MAINTAIN SPEED |
| a₂ | INCREASE SPEED |
| a₃ | DECREASE SPEED |
| a₄ | CHANGE LANE (LEFT) |
| a₅ | CHANGE LANE (RIGHT) |

For example, the processor 12 may perform reinforcement learning by assigning a negative reward to the training data set when autonomous driving is deactivated according to the first feedback signal. The processor 12 may control the behavior of the vehicle in a direction in which an autonomous driving state is maintained based on reinforcement learning results.

When the occupant overrides the system during autonomous driving, this means that a driving style of the vehicle is not satisfactory, and the processor 12 may reflect this situation as a negative reward (penalty, −Reward).

For example, when the vehicle accelerates too quickly (e.g., sudden bursts of acceleration or harsh throttle application) or changes lanes too aggressively (e.g., abrupt lane shifts without sufficient clearance) in the autonomous driving mode, the occupant may deactivate autonomous driving by gripping the steering wheel or pressing the brake, and when the processor 12 receives such a first feedback signal, the processor 12 may perform learning by recognizing the first feedback signal as a negative state and action.

For example, the processor 12 may assign negative reward data of −100 when the first feedback signal is input, and may assign reward data of 0 when the first feedback signal is not input.

For example, the processor 12 may use the second feedback signal to determine the positivity of the behavior of the occupant and perform reinforcement learning by assigning a positive reward or a negative reward to the training data set based on the positivity (e.g., assigning a positive reward when the occupant shows relaxed posture or calm heart rate, and assigning a negative reward when the occupant shows stressed voice input, anxious facial expressions, or abrupt corrective actions). The processor 12 may control the behavior of the vehicle in a direction in which a positive behavior of the occupant is induced based on reinforcement learning results (e.g., smoother speed control, steadier lane keeping, or gentler braking).

As described above, the processor 12 may analyze the second feedback signal and classify the second feedback signal according to whether the occupant determines the current state and action to be positive or negative. In addition, the processor 12 may calculate the degree of positivity and negativity as a score depending on the type of behavior of the occupant (e.g., +10 for a smile or relaxed body movement, −20 for a frown or tense posture, −50 for sudden brake override).

For example, the processor 12 may determine that the occupant feels uncomfortable when the heart rate increases based on a biometric signal and assign a negative reward to the training data set. In addition, the processor 12 may adjust a negative reward value depending on the degree of increase in heart rate (e.g., mild increase=−10, sharp increase=−50).

For example, the processor 12 may analyze an occupant's facial expression, body movements, eye-gaze direction, yawning frequency, or voice tone to determine whether the occupant feels uncomfortable or comfortable in the current state and action.

For example, in the case of a sudden steering wheel operation or strong pressure on the brake pedal in a manual driving state, the processor 12 may determine that the occupant feels uncomfortable and assign a negative reward to the training data set. In addition, the processor 12 may adjust the negative reward value depending on the steering angle and pedal pressure (e.g., slight correction=−5, sharp correction with high brake force=−80).

In addition, the processor 12 may determine whether the occupant feels uncomfortable or comfortable in the current state and action through a user's voice input. In addition, the processor 12 may analyze an occupant's comment using a natural language processing model and adjust a positive reward value or a negative reward value according to the occupant's comment (e.g., “too close to the car ahead,” “this feels smooth,” “braking is harsh,” or “lane change was comfortable”).

For example, when it is determined that the occupant is in an uncomfortable state, the processor 12 may assign a negative reward value of −30 to the training data set, and when it is determined that the occupant is in a slightly uncomfortable state, the processor 12 may assign a negative reward value of −10 to the training data set. Alternatively, when it is determined that the occupant is in a comfortable state, the processor 12 may assign a positive reward value of +20 (e.g., steady cruising, smooth braking, or gradual lane merging).

In this way, when the occupant sends a discomfort signal for a specific action, the processor 12 may perform reinforcement learning to lower the reward for the corresponding state and action so that the same state and action are not repeated.

When the occupant deactivates autonomous driving, reinforcement learning may be performed to prevent the same state and action from being repeated by lowering the reward for the state and action (e.g., sudden acceleration, a sudden lane change, or harsh braking) immediately before autonomous driving is deactivated.

Alternatively, when the occupant remains comfortable, the processor 12 may increase the reward for the corresponding state and action to reinforce a corresponding driving style (e.g., keeping safe distance, smooth acceleration, or natural lane following).

For example, when the first feedback signal that deactivates autonomous driving is generated as the occupant grips the steering wheel due to an overly aggressive lane change performed by the autonomous vehicle, the processor 12 may assign a negative reward for the state and action (rapid lane change) at the moment (e.g., rapid lane changes without clearance) when autonomous driving is deactivated. The processor 12 may then update the driving policy in a direction in which the lane change is suppressed in the same state.

For example, when the second feedback signal is generated due to a sudden change in speed by rapid acceleration performed by the vehicle, causing the occupant to lean back, the processor 12 may assign a negative reward for the action that includes rapid acceleration in the current state. The processor 12 may then update the driving policy to prefer gradual acceleration in the same state (e.g., speed increase of 2-3 km/h per second instead of sudden jumps).

For example, the processor 12 may assign a positive reward when the second feedback signal is generated as an action in which the vehicle naturally changes lanes while smoothly adjusting the speed (e.g., maintaining safe following distance, aligning with traffic flow, or avoiding abrupt steering corrections), thereby allowing the occupant to remain in a comfortable state (e.g., steady posture, calm biometric signals, or neutral facial expression). Then, the processor 12 may update the driving policy to perform smooth acceleration and lane changes more frequently in the same state so that similar comfort-enhancing driving behaviors are reinforced and repeated in future scenarios.

The first feedback signal and the second feedback signal may be simultaneously collected for the same state and action, and the processor 12 may analyze a feedback signal received from the sensor unit and classify the feedback signal as the first feedback signal or the second feedback signal.

The processor 12 may perform reinforcement learning by assigning a negative reward to the training data set using the feedback signal classified as the first feedback signal (e.g., deactivation of autonomous driving caused by gripping the steering wheel or pressing the brake pedal). Alternatively, the processor 12 may use the feedback signal classified as the second feedback signal to determine the positivity of the behavior of the occupant and perform reinforcement learning by assigning a positive reward (e.g., relaxed posture, calm heart rate, or verbal confirmation such as “good drive”) or a negative reward (e.g., anxious expression, increased heart rate, or a voice command such as “slow down”) to the training data set based on the positivity.

The processor 12 may assign a positive reward or a negative reward to the training data set based on at least one feedback signal among the first feedback signal and the second feedback signal, and perform reinforcement learning using the training data set to which the reward has been assigned.

FIGS. 7 to 9 show an exemplary operation of the processor 12 according to the example.

Referring to FIGS. 7 and 8 together, the processor 12 may calculate a driving trajectory of the vehicle based on the driving policy of the host vehicle and display the driving trajectory through the display.

The processor 12 may calculate the driving trajectory of the vehicle using a destination of the vehicle, external object recognition data, and vehicle driving data.

The processor 12 may detect adjacent vehicles, pedestrians, and obstacles using the external object recognition data, and predict the speed and moving direction of dynamic objects (moving vehicles, pedestrians, bicycles, or scooters). In addition, the processor 12 may analyze the current speed, acceleration, lane position, steering angle, slope, road surface condition (e.g., wet, icy, or uneven) of the host vehicle using the vehicle driving data.

The processor 12 may generate a trajectory along which the vehicle may travel while avoiding obstacles on a given road by applying the rapidly-exploring random tree (RRT) algorithm, the hybrid A* algorithm, Dijkstra's algorithm, or other path planning algorithms.

In addition, the processor 12 may predict movements of the adjacent vehicles and pedestrians using a Markov decision process (MDP), a Kalman filter, a particle filter, or a recurrent neural network (RNN)-based predictor, and calculate the driving trajectory to exclude trajectories having a risk of collision.

In addition, when a lane change is required, the processor 12 may determine a lane change start point, an end point, a lane change time point, and the like, at which the lane change may be made without colliding with an external object, and calculate the driving trajectory accordingly.

In this case, the processor 12 may generate a plurality of driving trajectories by considering driving safety, a driving distance, a driving time, a steering angle, and the degree of change in acceleration. For example, the processor 12 may generate a driving trajectory that may minimize a distance to an obstacle and a collision possibility, a driving trajectory that may minimize an acceleration/deceleration change rate, and a steering angle change amount, a driving trajectory that may maximize lane keeping and signal compliance (e.g., following traffic lights and speed limits), a driving trajectory that may minimize an expected arrival time, or an energy-efficient trajectory that reduces fuel or battery consumption.

The processor 12 may assign a driving trajectory score to each driving trajectory using the reinforcement learning model. The processor 12 may predict reward data for each point in time of each driving trajectory and calculate a driving trajectory score by adding up the reward data for each point in time for each driving trajectory.

For example, the processor 12 may use external object recognition data and vehicle driving data collected at a point in time t=0 to predict the speed and moving direction of a dynamic object at points in time t=1 to t=5 (e.g., predicting whether an adjacent vehicle will merge, slow down, or maintain its lane) and predict the driving state of the host vehicle to follow the driving trajectory.

The processor 12 may define relative positions of an external object at points in time t=1 to t=5 as a state of the training data set and define the driving state of the host vehicle as an action. The processor 12 may predict reward data corresponding to the state and action at points in time t=1 to t=5 based on the reinforcement learning model. That is, the processor 12 may retrieve a training data set including similar states and similar actions and calculate reward data for each point in time using the reward data in the retrieved training data set. In this case, the processor 12 may calculate the reward data at a corresponding point in time by averaging the reward data in the retrieved training data set.

The processor 12 may calculate the score of the driving trajectory connecting the points in time t=0 to t=5 by adding up the reward data for each point in time. The processor 12 may control the behavior of the vehicle to follow a trajectory having the highest driving trajectory score.

In this case, the processor 12 may visually display driving trajectory scores for the plurality of driving trajectories on the display (e.g., using different colors, line styles, or numerical labels for each candidate trajectory). The processor 12 may control the behavior of the vehicle to follow the trajectory having the highest driving trajectory score when the occupant inputs a driving trajectory based on the driving trajectory scores.

In addition, referring to FIG. 9 together, the processor 12 may evaluate the suitability of the driving trajectories based on the reward data. For example, the processor 12 may perform imitation learning based on a training data set on a driving trajectory having a driving trajectory score greater than or equal to a preset threshold value (e.g., a trajectory that ensures smooth lane changes, reduced acceleration fluctuations, or safe distance from adjacent vehicles) and control the behavior of the host vehicle. That is, the processor 12 may extract only driving trajectories having a driving trajectory score greater than or equal to a certain value and perform imitation learning using a training data set generated based on the extracted driving trajectories so that future trajectory calculations replicate safe, efficient, and comfortable patterns. When the driving trajectory score is greater than or equal to a certain value, this may mean that the ride comfort of the occupant is greater than or equal to a certain level. Accordingly, the processor 12 may perform imitation learning to learn only a training data set of a driving trajectory in which the occupant feels a ride comfort equal to or greater than a certain level, thereby allowing the ride comfort of the occupant to be reflected when determining the behavior of the vehicle in the future (e.g., preferring gradual lane changes, smoother braking, or steadier cruising speeds).

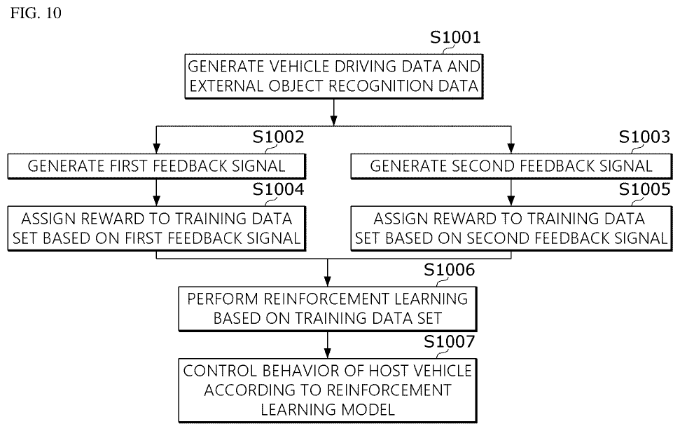

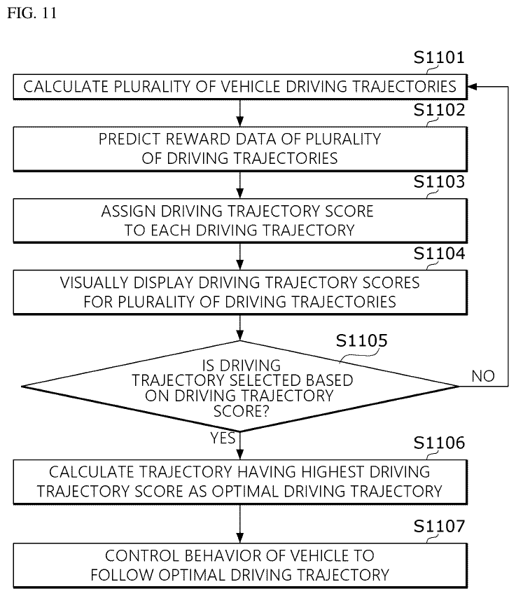

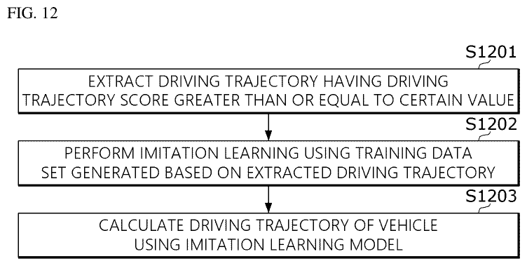

FIG. 10 is a flowchart of a vehicle control method according to an example.

Referring to FIG. 10, a sensor unit generates vehicle driving data and external object recognition data of a host vehicle (S1001).

The sensor unit generates a first feedback signal based on at least one of an autonomous driving deactivation signal input through the operating unit and an autonomous driving deactivation signal input based on the behavior of an occupant detected inside the vehicle (S1002). For example, the first feedback signal may be generated when the occupant presses the brake pedal, grips the steering wheel, or turns off an autonomous driving switch.

Alternatively, the sensor unit may generate a second feedback signal based on at least one of a signal input through the operating unit and the behavior of the occupant detected inside the vehicle (S1003). For example, the second feedback signal may include a biometric change (e.g., increased heart rate), a physical action (e.g., leaning forward or sudden posture change), or a voice input (e.g., “driving too fast” or “smooth ride”).

A processor may assign a negative reward to a training data set when autonomous driving is deactivated according to the first feedback signal (S1004).

Alternatively, the processor may use the second feedback signal to determine the positivity of the behavior of the occupant and assign a positive reward or a negative reward to the training data set based on the positivity (S1005). For example, a calm heart rate may be assigned a positive reward, while a stressed voice command such as “stop” may be assigned a negative reward.

In this way, the processor may assign a positive reward or a negative reward to the training data set based on at least one feedback signal among the first feedback signal and the second feedback signal.

Next, the processor may perform reinforcement learning based on the training data set and control the behavior of the host vehicle. For example, based on reinforcement learning results, the processor may determine the behavior of the vehicle in a direction in which the autonomous driving state is maintained or determine the behavior of the vehicle in a direction in which a positive behavior of the occupant is induced (S1006 and S1007) (e.g., maintaining lane centering to reduce discomfort or adjusting acceleration to achieve smoother cruising, etc.)

FIG. 11 is a flowchart of a vehicle control method according to another example.

Referring to FIG. 11, a processor calculates a driving trajectory of a vehicle using a destination of the vehicle, external object recognition data, and vehicle driving data. The processor may generate a plurality of driving trajectories by considering driving safety, a driving distance, a driving time, a steering angle, and the degree of change in acceleration (S1101). For example, one trajectory may prioritize shortest travel time, another may prioritize smoother steering angles, and another may prioritize maximum safety distance from obstacles.

Next, the processor may predict reward data corresponding to the state and action at each point in time of the plurality of driving trajectories based on a reinforcement learning model. That is, the processor may retrieve a training data set including similar states and similar actions and calculate reward data for each point in time using the reward data in the retrieved training data set (S1102) (e.g., predicting whether maintaining speed in heavy traffic will yield low comfort, whether gradual acceleration will increase comfort, or whether a sharp lane change will reduce safety).

Next, the processor assigns a driving trajectory score to each driving trajectory using the reinforcement learning model. The processor may predict reward data for each point in time for each driving trajectory and calculate a driving trajectory score by adding up the reward data for each point in time for each driving trajectory. The processor may calculate a score for a corresponding driving trajectory by adding up the reward data for each point of time in the driving trajectory (S1103). For instance, a trajectory with smooth speed changes and fewer lane shifts may score higher than one with abrupt accelerations and frequent lane changes.

Next, the processor visually displays driving trajectory scores for the plurality of driving trajectories on the display (S1104). For example, the display may show the trajectories in different colors or highlight the trajectory with the highest score for easy selection.

Next, when the occupant selects a driving trajectory based on the driving trajectory score through the operating unit, the processor calculates a trajectory having the highest driving trajectory score as an optimal driving trajectory and controls the behavior of the vehicle to follow the optimal driving trajectory (S1105 to S1107).

FIG. 12 is a flowchart of a vehicle control method according to still another example.

Referring to FIG. 12, a processor extracts a driving trajectory having a driving trajectory score greater than or equal to a certain value (S1201).

Next, the processor performs imitation learning using a training data set generated based on the extracted driving trajectory (S1202). For example, only trajectories with smooth lane changes, minimal jerk forces, or high safety margins may be extracted for imitation learning.

Next, the processor calculates a driving trajectory of a vehicle using an imitation learning model (S1203). The imitation learning model may then produce future trajectories that replicate the characteristics of high-scoring trajectories (e.g., safe, efficient, or comfortable driving patterns).

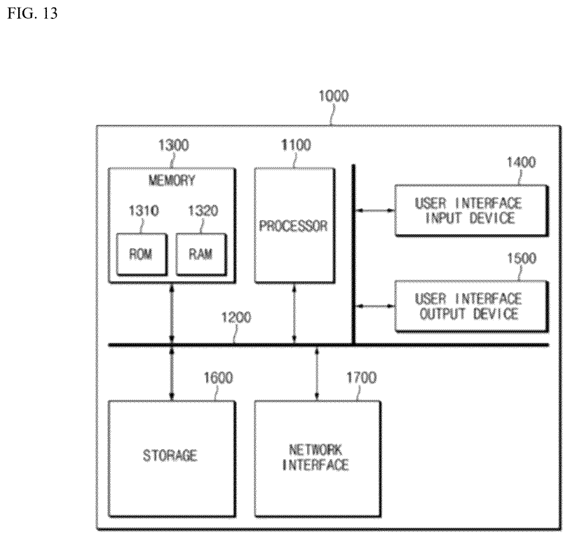

FIG. 13 shows an example computing system (e.g., a computing device of a vehicle or any other apparatus). One or more controllers, processors, etc. described herein, such as one or more components of the vehicle 100 (e.g., DCCU), one or more components of the management server 200, one or more components of the user terminal 300, and any other components and devices disclosed herein, may be implemented by or in the computing system as shown in FIG. 13.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to an example of the present disclosure, there is provided a vehicle control device including a sensor unit, one or more processors, and a memory storing one or more programs executed by the one or more processors, in which the sensor unit generates vehicle driving data and external object recognition data of a host vehicle and generates a feedback signal input from an occupant during travel of the host vehicle, and the processor is configured to generate reward data based on the feedback signal, generate a training data set including the external object recognition data, the vehicle driving data, and the reward data, and perform reinforcement learning based on the training data set and control the vehicle based on the reinforcement learning.

The sensor unit may generate a first feedback signal based on at least one of an autonomous driving deactivation signal input through an operating unit and an autonomous driving deactivation signal input based on behavior of the occupant detected inside the vehicle.

The processor may perform the reinforcement learning by assigning a negative reward to the training data set when autonomous driving is deactivated according to the first feedback signal.

The processor may control the vehicle in a direction in which an autonomous driving state is maintained based on results of the reinforcement learning.

The sensor unit may generate a second feedback signal based on at least one of a signal input through an operating unit and behavior of the occupant detected inside the vehicle.

The processor may use the second feedback signal to determine positivity of the behavior of the occupant and perform the reinforcement learning by assigning a positive reward or a negative reward to the training data set based on the positivity.

The processor may control the vehicle in a direction in which a positive behavior of the occupant is induced based on results of the reinforcement learning.

The processor may calculate a driving trajectory of the vehicle based on the reinforcement learning and display the driving trajectory through a display.

The processor may evaluate suitability of the driving trajectory based on the reward data.

The processor may perform imitation learning based on a training data set having a driving trajectory score greater than or equal to a preset threshold value, and control the vehicle based on results of the imitation learning and the reinforcement learning.

According to another example of the present disclosure, there is provided a vehicle control method performed by a computing device including a sensor unit, one or more processors, and a memory storing one or more programs executed by the one or more processors, including generating, by the sensor unit, vehicle driving data and external object recognition data of a host vehicle and generating a feedback signal input from an occupant during travel of the host vehicle, generating, by the processor, reward data based on the feedback signal, generating, by the processor, a training data set including the external object recognition data, the vehicle driving data, and the reward data, and performing, by the processor, reinforcement learning based on the training data set and controlling the vehicle based on the reinforcement learning.

The sensor unit may generate a first feedback signal based on at least one of an autonomous driving deactivation signal input through an operating unit and an autonomous driving deactivation signal input based on behavior of the occupant detected inside the vehicle.

The processor may perform the reinforcement learning by assigning a negative reward to the training data set when autonomous driving is deactivated according to the first feedback signal.

The processor may control the vehicle in a direction in which an autonomous driving state is maintained based on results of the reinforcement learning.

The sensor unit may generate a second feedback signal based on at least one of a signal input through an operating unit and behavior of the occupant detected inside the vehicle.

The processor may use the second feedback signal to determine positivity of the behavior of the occupant and perform the reinforcement learning by assigning a positive reward or a negative reward to the training data set based on the positivity.

The processor may control the vehicle in a direction in which a positive behavior of the occupant is induced based on results of the reinforcement learning.

The processor may calculate a driving trajectory of the vehicle based on the reinforcement learning and display the driving trajectory through a display.

The processor may evaluate training suitability of the training data set based on the reward data, and assign a training suitability score according to an evaluation result.

The processor may perform imitation learning based on a training data set having a training suitability score greater than or equal to a preset threshold value, and control the vehicle based on results of the imitation learning and the reinforcement learning.

The vehicle control device according to the example may further specify a reward function of the autonomous vehicle by utilizing the feedback of an occupant. For example, when the occupant feels uncomfortable during driving or deactivates autonomous driving, this means that the driving policy of the vehicle is not optimal, so this feedback may be reflected in a reward design of reinforcement learning. For example, when the occupant deactivates autonomous driving by gripping the steering wheel or pressing the brake, a negative reward may be assigned by analyzing a state and driving operation of the vehicle at that moment.

In addition, when the occupant expresses anxiety due to operations such as rapid acceleration/deceleration, excessive lane changes, or the like while driving, this may be reflected in a reward model to induce more natural and stable driving. This method has the advantage of being able to reflect more realistic driving data than an existing standardized reward function design.

In addition, the present disclosure may increase the learning efficiency of a reinforcement learning model by utilizing a large amount of raw driving perception (RDP) logs. Since reinforcement learning is a method of collecting data through interaction with the environment, the quality and diversity of training data are important, so that through the RDP logs, a large amount of actual driving data may be secured and utilized for learning. In addition, a reward function may be designed by applying the reward model in a reinforcement learning process, and in this way, it is possible to more precisely optimize the driving policy.

In addition, the present disclosure may also be applied to imitation learning. Imitation learning is a method of learning policies based on driving data from experts, and unlike reinforcement learning, requires explicit labeled data. However, since not all driving data contain expert-level optimal actions, the selection of training data becomes an important task. By applying the present disclosure, it is possible to utilize the feedback of an occupant as an index for selecting optimal data, thereby improving the performance of imitation learning.

In addition, the method according to the present disclosure may be usefully utilized to evaluate the performance of various planners to be developed in the future. Representative planners used in autonomous driving systems include model predictive control (MPC), rule-based, and learning-based methods, and each method has specific strengths and limitations. The present disclosure provides an index that may make an evaluation based on the feedback of the occupant for a driving trajectory generated by a planner, and this index may be utilized as a reference for verifying whether the output of each planner is valid in an actual driving environment. In addition, the index may be used as a reference for selecting an optimal trajectory among the driving trajectory candidates generated by various planners by considering the preference and safety of the occupant.

With a vehicle control device and method according to an example, it is possible to control a vehicle by designing a reward function based on feedback from occupants in a reinforcement learning-based autonomous driving system, thereby reflecting specific and realistic data.

In addition, in this way, it is possible to improve the efficiency and performance of reinforcement learning.

In addition, by selecting training data for imitation learning based on a reward function, it is possible to improve the learning performance of the imitation learning.

Although the preferred examples of the present disclosure have been described above, it is understood that those skilled in the art may make various changes and modifications to the present disclosure without departing from the spirit and scope of the present disclosure set forth in the claims below.

What is claimed is:

1. An apparatus of a vehicle, the apparatus comprising:
a sensor;
a processor; and
a memory storing at least one instruction that, when executed by the processor communicating with the memory, is configured to cause the apparatus to:
obtain, from the sensor, vehicle driving data associated with the vehicle and external object recognition data associated with an object in a surrounding environment of the vehicle,
based on input from an occupant of the vehicle during travel of the vehicle, generate a feedback signal,
generate, based on the feedback signal, weight data,
generate a training data set, the training data set comprising the external object recognition data, the vehicle driving data, and the weight data,
perform, based on the training data set, reinforcement learning to adjust control parameters associated with autonomous driving of the vehicle, and
control, based on the adjusted control parameters, autonomous driving of the vehicle.

2. The apparatus of claim 1, wherein the sensor is configured to generate a first feedback signal, wherein the first feedback signal is generated based on at least one of a first autonomous driving deactivation signal or a second autonomous driving deactivation signal, wherein the first autonomous driving deactivation signal is generated based on a signal obtained via an input interface of the vehicle, and wherein the second autonomous driving deactivation signal is generated based on a detected behavior of the occupant.

3. The apparatus of claim 2, wherein the at least one instruction, when executed by the processor communicating with the memory, is configured to cause the apparatus to, based on autonomous driving being deactivated according to the first feedback signal, perform the reinforcement learning by assigning a negative weight to the training data set.

4. The apparatus of claim 3, wherein the at least one instruction, when executed by the processor communicating with the memory, is configured to cause the apparatus to control, based on the reinforcement learning, the vehicle in a direction in which an autonomous driving state is maintained.

5. The apparatus of claim 1, wherein the sensor is configured to generate a second feedback signal based on at least one of:
an input signal generated based on a user input received via an input interface of the vehicle, or
a detected behavior of the occupant.

6. The apparatus of claim 5, wherein the at least one instruction, when executed by the processor communicating with the memory, is configured to cause the apparatus to:
determine, based on the second feedback signal, a positivity value associated with a behavior of the occupant, and
perform, based on the positivity value, the reinforcement learning by assigning a positive weight or a negative weight to the training data set.

7. The apparatus of claim 6, wherein the at least one instruction, when executed by the processor communicating with the memory, is configured to cause the apparatus to control, based on the reinforcement learning, the vehicle in a direction in which a positive behavior of the occupant is induced.

8. The apparatus of claim 1, wherein the at least one instruction, when executed by the processor communicating with the memory, is configured to cause the apparatus to:
determine, based on the reinforcement learning, a driving trajectory of the vehicle, and
display, via a display, the driving trajectory.

9. The apparatus of claim 8, wherein the at least one instruction, when executed by the processor communicating with the memory, is configured to cause the apparatus to determine, based on the weight data, suitability of the driving trajectory.

10. The apparatus of claim 9, wherein the at least one instruction, when executed by the processor communicating with the memory, is configured to cause the apparatus to:
based on a training data set having a driving trajectory score greater than or equal to a preset threshold value, perform imitation learning, and
based on the imitation learning and the reinforcement learning, control autonomous driving of the vehicle.

11. A method performed by an apparatus of a vehicle, the method comprising:
obtaining, from a sensor of the vehicle, vehicle driving data associated with the vehicle and external object recognition data associated with an object in a surrounding environment of the vehicle;
based on input from an occupant of the vehicle during travel of the vehicle, generating a feedback signal;
generating, based on the feedback signal, weight data;
generating a training data set, the training data set comprising the external object recognition data, the vehicle driving data, and the weight data;
performing, based on the training data set, reinforcement learning to adjust control parameters associated with autonomous driving of the vehicle; and
controlling, based on the adjusted control parameters, autonomous driving of the vehicle.

12. The method of claim 11, further comprising:
generating, via the sensor, a first feedback signal, wherein the first feedback signal is generated based on at least one of a first autonomous driving deactivation signal or a second autonomous driving deactivation signal, wherein the first autonomous driving deactivation signal is generated based on a signal obtained via an input interface of the vehicle, and wherein the second autonomous driving deactivation signal is generated based on a detected behavior of the occupant.

13. The method of claim 12, further comprising:
based on autonomous driving being deactivated according to the first feedback signal, performing the reinforcement learning by assigning a negative weight to the training data set.

14. The method of claim 13, further comprising:
based on the reinforcement learning, controlling the vehicle in a direction in which an autonomous driving state is maintained.

15. The method of claim 11, further comprising:
generating, via the sensor, a second feedback signal based on at least one of:
an input signal input generated based on a user input received via an input interface of the vehicle, or
a detected behavior of the occupant.

16. The method of claim 15, further comprising:
determining, based on the second feedback signal, a positivity value associated with a behavior of the occupant, and
performing, based on the positivity value, the reinforcement learning by assigning a positive weight or a negative weight to the training data set.

17. A vehicle comprising:
a sensor;
a driving control circuit configured to control autonomous driving of the vehicle; and
a processor circuit configured to cause the vehicle to:
obtain, from the sensor, driving data associated with the vehicle and external object data associated with an object in a surrounding environment of the vehicle,
detect a feedback signal associated with an occupant of the vehicle during travel of the vehicle, wherein the feedback signal indicates at least one of a manual override action, a biometric change, a physical action, or a voice input,
generate, based on the feedback signal, control adjustment data,
determine a training data set, the training data set comprising the driving data, the external object data, and the control adjustment data,
perform, based on the training data set, a learning process to adjust a set of autonomous driving control parameters of the driving control circuit, and
control, via the driving control circuit and based on the adjusted set of autonomous driving control parameters, autonomous driving of the vehicle.

18. The vehicle of claim 17, wherein the processor circuit is configured to cause the vehicle to assign a negative weight to the training data set when the feedback signal corresponds to deactivation of autonomous driving.

19. The vehicle of claim 17, wherein the processor circuit is configured to cause the vehicle to assign a positive weight or a negative weight to the training data set according to whether the feedback signal indicates comfort or discomfort of the occupant of the vehicle.

20. The vehicle of claim 17, wherein the processor circuit is configured to cause the vehicle to perform, based on a second training data set, imitation learning, wherein the second training data set is associated with a driving trajectory having a suitability score satisfying a threshold value, and wherein the processor circuit is configured to cause the vehicle to control the autonomous driving of the vehicle such that driving behavior corresponding to a positive feedback signal associated with the occupant is retained and driving behavior corresponding to a negative feedback signal associated with the occupant is suppressed.
